(19) United States
(12) Patent Application Publication
(10) Pub. No.: US 2016/0006097 A1
(43) Pub. Date: Jan. 7, 2016

(54) FILTER DEVICE

(71) Applicant: Chung Yuan Christian University, Zhongli City (TW)

(72) Inventor: Guang-Hwa SHIUE, Zhongli City (TW)

(21) Appl. No.: 14/470,623

(22) Filed: Aug. 27, 2014

(30) Foreign Application Priority Data
Jul. 4, 2014 (TW) 103123213

(51) Int. Cl. H01P 1/201

(52) U.S. Cl. CPC H01P 1/2013

(57) ABSTRACT

Disclosed herein is a filter device for suppressing ground bounce and electromagnetic interference. The filter device comprises a dielectric substrate, a signal transmission layer, a signal via, a plurality of ground vias, and first, second, and third metal layers. The signal transmission layer is located on the dielectric substrate, the vias and the first and second metal layers in the dielectric substrate, and the third metal layer underneath it. The first metal layer has a filter portion and a resonance portion. The ground vias connect the second and third metal layers and are disposed perpendicularly to them. The signal via, disposed in a via space defined by the ground vias, connects the first metal layer and the signal transmission layer. As a result, the resonance portion is able to reduce noise of a certain frequency band, the ground vias abate ground bounce, and electromagnetic interference is minimized.

### CROSS-REFERENCE TO RELATED APPLICATIONS

This non-provisional application claims priority under 35 U.S.C. §119(a) on Patent Application No. 103123213 filed in Taiwan, R.O.C. on Jul. 4, 2014, the entire contents of which are hereby incorporated by reference.

### TECHNICAL FIELD

The present invention relates to a filter device, particularly to one for power transmission.

### BACKGROUND

Modern technological developments bring about a plethora of high-frequency electronics, the incessant increasing of whose digital transmission rates are shadowed by a host of telecommunication problems, such as signal integrity, power integrity, electromagnetic interference (EMI), electromagnetic compatibility, etc. Signal integrity and quality are what separate good circuit designs from bad ones. A quarter-wave resonator is generally enough for reducing noise of a certain frequency band, but with it there is often also ground bounce and significant EMI.

A filter device, therefore, is desperately called for to abate ground bounce and suppress EMI, so that digital signal integrity and quality can be preserved in the circuit design.

### SUMMARY

In light of the above, the present invention discloses a filter device, in which multi-layered structure a signal via is disposed in a via space defined by a plurality of ground vias. The filter device reduces ground bounce and the EMI between a power line and a piece of equipment, so that signal integrity and quality are preserved in the filter device.

Said filter device comprises a dielectric substrate, a signal transmission layer, said signal via, said ground vias, and first, second, and third metal layers. The signal transmission layer is located on the dielectric substrate. The signal via, the ground vias, and the first and second metal layers are located in the dielectric substrate. The third metal layer is located underneath the dielectric substrate and disposed parallel to and below the first metal layer. The first metal layer has a filter portion and a resonance portion. The second metal layer has a hole and is disposed parallel to and above the first metal layer. The ground vias connect the second and third metal layers and are disposed perpendicularly to them. The ground vias define a via space in which the signal via is disposed perpendicularly to the first metal layer and the signal transmission layer. The signal via connects the first metal layer and the signal transmission layer through the hole of the second layer.

In one embodiment, the metal and signal transmission layers all have a first thickness. In another, distances between the first and second metal layers, between the first and third metal layers, and between the second metal layer and the signal transmission layer are all a first inter-layer distance. The signal via and the ground vias may have first and second diameters, respectively. In one embodiment, the ground vias equidistantly surround the signal via, thereby defining the via space.

In short, the filter device as disclosed may be disposed between the equipment and its power line to abate ground bounce and the EMI of signal transmission thereabout. EMI signals are usually high-frequency, so the filter device may be a band-stop one that preserves signal integrity and quality.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a top view of a filter device in accordance with an embodiment of the present invention.

FIG. 2 is a cross-sectional view of a filter device in correspondence with FIG. 1 and in accordance with an embodiment of the present invention.

FIG. 3 is another cross-sectional view of a filter device in correspondence with FIG. 1 and in accordance with an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

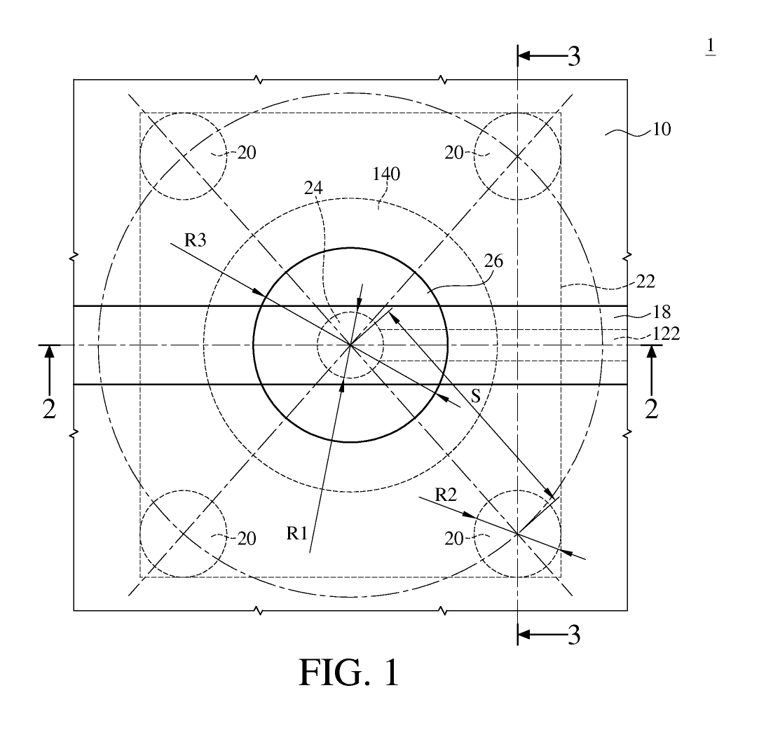

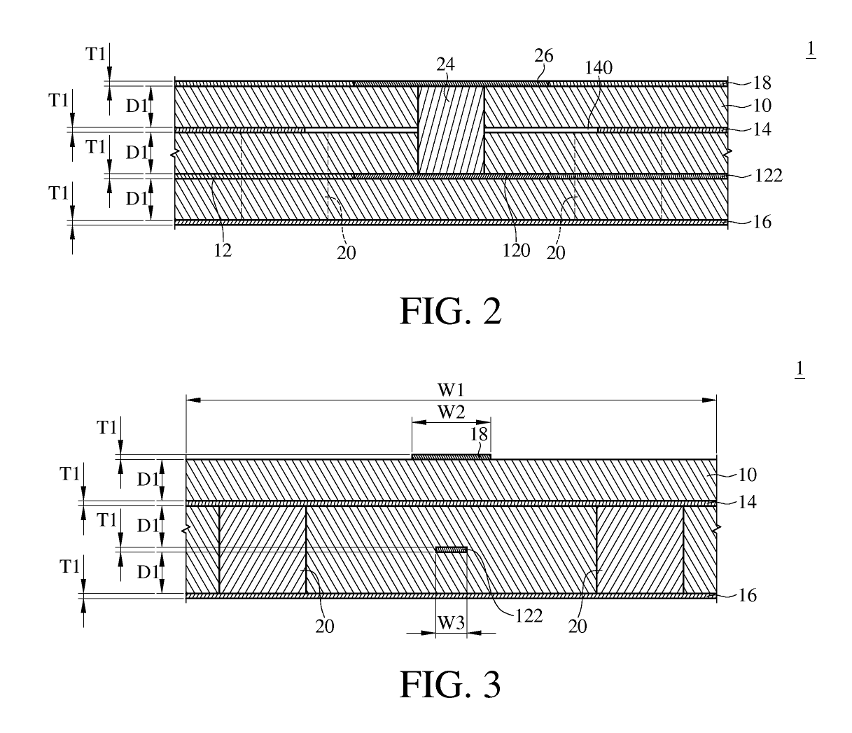

Please refer to FIGS. 1 and 2, respectively top and cross-sectional views of a filter device 1 of the present invention. The filter device 1 comprises a dielectric substrate 10, a first metal layer 12, a second metal layer 14, a third metal layer 16, a signal transmission layer 18, a plurality of ground vias 20, and a signal via 24.

The dielectric substrate 10 has a dielectric constant and is made of dielectric material known to and customizable by persons skilled in the art. The first metal layer 12 is located in the dielectric substrate 10 and has a resonance portion 120 and a filter portion 122. The resonance portion 120 may be a quarter-wave (λ/4) resonator that is strip-constructed. The filter portion 122 may be laid out as a coplanar waveguide to be connected in series and in parallel with the resonance portion 120 on a reduced circuit area. Forms of the resonance portion 120 and the filter portion 122 are again customizable by persons skilled in the art.

The second metal layer 14 has a hole 140 and is disposed parallel to and above the first metal layer 12 in the dielectric substrate 10. The hole 140 divides the second metal layer 14 into two parts. The third metal layer 16 is disposed parallel to and below the first metal layer 12 underneath the dielectric substrate 10. The signal transmission layer 18, located on the dielectric substrate 10, may be a microstrip or metal wire for delivering signals within the filter device 1 to an external electrode. Said layers 12, 14, 16, and 18 are one by one separated by the dielectric substrate 10.

In one embodiment, the layers 12, 14, 16, and 18 all have a first thickness T1. In another, distances between the metal layers 12 and 14, between the metal layers 12 and 16, and between the second metal layer 14 and the signal transmission layer 18 are all a first inter-layer distance D1. T1 may be less than D1; for example, T1 may be 1.2 mils and D1 may be 10 mils, where a mil is approximately 25.4 μm.

The ground vias 20 are electrically connected with a ground and disposed perpendicularly to the metal layers 14 and 16 in the dielectric substrate 10. The metal layers 14 and 16 are connected by the ground vias 20, the number of which is by no means limited by the present invention and is assumed to be four in FIG. 1. The ground vias 20 define a via space 22. The signal via 24 is located in the dielectric substrate 10 and disposed in the via space 22 perpendicularly to the first metal layer 12 and the signal transmission layer 18. The layers 12 and 18 are connected by the signal via 24 through the hole 140. The signal via 24 primarily serves to deliver signals within the filter device 1 to the signal transmission layer 18.

The vias 20 and 24, materially customizable by persons skilled in the art, may all be solid metal bodies. In one embodiment, the via space 22 is defined by the ground vias 20 equidistantly surrounding the signal via 24. Specifically, when viewed from the top as in FIG. 1, the ground vias 20 occupy the four corners of a rectangular cuboid that is the via space 22, and the circular origin of the signal via 24, coinciding with the center of mass of the rectangular cuboid, is a distance S away from the circular origin of each of the ground vias 20.

In one embodiment, the signal via 24 has a first diameter R1 and the ground vias 20 have a second diameter R2. R1 may be less than R2; for example, R1 may be 16 mils and R2 may be 21 mils. S is greater than both R1 and R2.

In one embodiment, the filter device 1 further comprises a metal pad 26 disposed in the signal transmission layer 18, connected to the signal via 24, and having a third diameter R3. R3 may be greater than R1; for example, R3 may be 47 mils when R1 is 16 mils.

Please refer to FIG. 3, which is another cross-sectional view of the filter device 1. As shown in FIG. 3, both the metal layers 14 and 16, as wide as the dielectric substrate 10, have a first width W1. The signal transmission layer 18 has a second width W2, whereas the filter portion 122 has a third width W3. W3 may be less than W2, which in turn may be less than W1. For example, W2 and W3 may be 19 and 7.5 mils, respectively, when W1 is 27.5 mils.

Ground bounce might occur when the resonance portion 120 operates, but can be suppressed when the ground vias 20, equidistantly disposed with regard to the signal via 24 and thus defining the via space 22, are instrumental in abating near-field radiation of various frequency bands. What is more, as a strip structure, the resonance portion 120 can abate electromagnetic radiation in addition to preserving signal integrity. A more complete filtering effect, therefore, is achieved in the filter device 1.

In conclusion, a filter device of the present invention may be disposed in a circuit and applied between a piece of electronic equipment and its power line. The filter device comprises a plurality of ground vias for abating ground bounce, and a strip-constructed resonance portion to suppress the EMI of signal transmission between the filter device and the power line. EMI signals are usually high-frequency; hence the filter device is able to preserve digital signal integrity and quality.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

1. A filter device for suppressing ground bounce, the filter device comprising:
a dielectric substrate made of dielectric material;
a first metal layer located in the dielectric substrate and having a filter portion and a resonance portion;
a second metal layer located in the dielectric substrate, disposed parallel to and above the first metal layer, and having a hole;
a third metal layer located underneath the dielectric substrate and disposed parallel to and below the first metal layer;
a signal transmission layer located on the dielectric substrate;
a plurality of ground vias located in the dielectric substrate, disposed perpendicularly to the second metal layer and the third metal layer, connecting the second metal layer and the third metal layer, and defining a via space; and
a signal via located in the dielectric substrate, disposed in the via space perpendicularly to the first metal layer and the signal transmission layer, and connecting the first metal layer and the signal transmission layer through the hole,
wherein the signal transmission layer has a second width, the filter portion has a third width, and the second width is greater than the third width; and
wherein the filter portion and the resonance portion are completely disposed at the first metal layer, the resonance portion is located around the signal via symmetrically, and the filter portion is located adjacent to the resonance portion and located at one side of the signal via.

2. The filter device of claim 1, wherein the first metal layer, the second metal layer, the third metal layer, and the signal transmission layer all have a first thickness.

3. The filter device of claim 2, wherein distances between the first metal layer and the second metal layer, between the first metal layer and the third metal layer, and between the second metal layer and the signal transmission layer are all a first inter-layer distance.

4. The filter device of claim 3, wherein the first thickness is less than the first inter-layer distance.

5. The filter device of claim 1, wherein the signal via has a first diameter, the ground vias have a second diameter, and the first diameter is less than the second diameter.

6. The filter device of claim 5, wherein the ground vias equidistantly surround the signal via in the via space.

7. The filter device of claim 5, further comprising a metal pad disposed in the signal transmission layer, connected to the signal via, and having a third diameter.

8. The filter device of claim 7, wherein the third diameter is greater than the first diameter.

9. The filter device of claim 1, wherein both the second metal layer and the third metal layer have a first width.

10. (canceled)

11. The filter device of claim 9, wherein the first width is greater than the second width.
